(19) United States
(12) Patent Application Publication
(10) Pub. No.: US 2004/0088408 A1
(43) Pub. Date: May 6, 2004

(54) Methods and systems for routing requests at a network switch

(76) Inventor: Igor Tsyganskiy, Los Gatos, CA (US)

Correspondence Address: Finnegan, Henderson, Farabow,, Garrett & Dunner, L.L.P., 1300 I Street, N.W., Washington, DC, 20005-3315, US

(21) Appl. No.: 10/286,108

(22) Filed: Nov. 1, 2002

(51) Int. Cl. G06F 15/173

(52) U.S. Cl. 709/225

(57) ABSTRACT

Methods and systems are disclosed for evaluating a user request in a network environment, such as a Web-based environment. In an exemplary method for handling a request, the method comprises receiving a request at a network switch, evaluating the request based on a rule, and handling the request based on the evaluation of the rule.

### BACKGROUND OF THE INVENTION

I. Field of the Invention

The present invention generally relates to the field of communications and to the handling or routing of network requests. More particularly, the invention relates to methods and systems for routing requests at, for example, a network switch.

II. Background and Material Information

The Internet, fueled by the phenomenal popularity of the World Wide Web (the “Web”), has exhibited exponential growth over the past few years. On the Web, the ease of self-publication via user-created “Web pages” has helped generate tens of millions of documents on a broad range of subjects, all capable of being displayed to a user with access to the Web.

Users can access information on the Web using standard computer equipment, such as a personal computer with a display and modem connected to the Internet. Several types of Internet connections are available, including connections through Internet Service Providers (ISPs). To use an Internet connection from an ISP, for example, a user can electronically connect his personal computer to a server at the ISP's facility using the modem and a standard telephone line or a local area network (LAN) connection. The ISP's server in turn provides the user with access to the Internet.

Typically, a user accesses information using a computer program called a “Web browser.” A Web browser provides an interface to the Web. Examples of Web browsers include Netscape Navigator™ from Netscape Communications Corporation or Internet Explorer™ from Microsoft Corporation. To view a Web page, the user enters the Web page's Uniform Resource Locator (URL) address to instruct the Web browser to access the Web page. The user, via the Web browser, can view or access an object in the Web page, for example, a document containing information of interest. The Web browser retrieves the information and visually displays it to the user.

Web pages are programmed using a computer language such as hypertext markup language (HTML). HTML files (or “.htm” files) are stored on a server (“Web server”) and define the content and layout of Web pages. When a user enters a URL address into a Web browser, the URL address is used by the Web browser to locate a Web page stored on a Web server. Communication between the user's browser and a Web server is based on a request/response paradigm involving Hypertext Transfer Protocol (HTTP) or other known protocols. When an HTTP request is made by the browser (such as to view a Web page), the Web server provides a response (to permit the Web page to be displayed by the browser). As a result, such interactions follow a client/server relationship, in which the browser on a user's computer serves as the “client” and a Web server acts as the “server.”

Before reaching the server, requests from the client must move through the Internet. Typically, requests are directed or routed from the client to the server though a series of routers or network switches. Upon receipt of the request, the server accesses the requested page and provides a response containing the requested page to the client.

Requests from a client may contain a URL, a query string, POST parameters, as well as information identifying the client. As indicated above, a URL indicates the Web address of the requested page. A server may use the URL to access the requested page from, for example, a database or a Web-based application. A request may also contain data transmitted using a query string or POST parameter. Query strings and POSTs are parameters used to submit data to the server based on the client's actions within the requested page. For example, the parameters may be used to submit data associated with a client's requests.

Web servers and other processes that handle client requests for services, such as requests for a Web page, may require significant server resources. For example, a server may perform processing cycles to build and transmit a response to a request. Some requests may require the server to invoke one or more processes, each providing a component of the response. In one example, a request may seek information from a database that is housed by a database computer. This may require the server to invoke a process to communicate with the database computer. The database computer may then invoke a separate process to handle access to and retrieval from the database. These process intensive requests may prolong the amount of time to respond to a request, otherwise called a response time.

The response time is typically a function of the server load. For example, as the load on the server increases, the response time typically increases. As the response time increases the client experience deteriorates. Response times are typically not taken into account when routing requests to servers. The priority of a user making a request is also typically not taken into account when routing requests to servers. Further, the integrity of the request is not taken into account when routing requests to servers. Accordingly, there is a need for improved methods and systems for routing requests in a network environment. Moreover, there is a need for systems and methods that are capable of evaluating requests before routing requests to a server.

### SUMMARY OF THE INVENTION

Methods and systems consistent with embodiments of the present invention provide an improved framework for handling and routing requests in a network environment. In accordance with one embodiment of the invention, a method is provided for handling a request conducted in a network environment, such as a Web-based environment The method comprises: receiving a request at a network switch; evaluating the request based on a rule; and handling the request based on the evaluation of the rule.

In accordance with one embodiment of the invention, a method is provided for evaluating a user request conducted in a network environment, such as a Web-based environment The method comprises: receiving a request at a network switch; determining the processing intensity of the request; assessing a plurality of servers or web service in the network environment to determine the relative processing loads of the servers; and routing the request to one of the plurality of servers based on the determined intensity and the relative processing loads.

In accordance with another embodiment of the invention, a method is provided for routing a request in a network environment including at least one network switch and one or more servers. The method comprises: receiving a request at a network switch; determining a security risk associated with the request; handling the request based on the determined security risk; and routing the request to a server based on the security risk of the request.

Consistent with another embodiment of the invention, a method is provided for routing a request in a network environment including at least one network switch and a plurality of servers. The method comprises: receiving a request at a network switch; determining a priority level of the request, the priority level indicating a minimum response time; assessing a plurality of servers to determine a relative response time of each server; and routing the request to one of the plurality of servers based on the relative response time for the priory level associated with the request. In the exemplary method, the request may be routed based on a minimum response time.

In accordance with yet another embodiment of the invention, a method is provided for use in a network environment including a plurality of servers. The method comprises: evaluating a network request/response log; determining a response time for at least one type of request, based on the evaluation of the log; and modifying the structure of a plurality of servers based on the determined request/response time. The exemplary method may further comprise routing the request to one of the plurality of servers based on the type of request and/or inserting auxiliary data into the request.

Consistent with still another embodiment of the invention, a method is provided for determining request evaluation criteria. The method comprises: generating rules for handling requests based on request/response logs and server data; generating parameters for the rules based a set of current requests; and updating evaluation criteria based on the generated rules and parameters.

It is to be understood that both the foregoing general description and the following detailed description are exemplary and explanatory only and are not restrictive of the embodiments of the present invention, as claimed.

### BRIEF DESCRIPTION OF THE DRAWINGS

The accompanying drawings, which are incorporated in and constitute a part of this specification, together with the description, serve to explain features and exemplary embodiments of the invention. In the drawings:

FIG. 1 is a pictorial diagram illustrating a client/server environment for capturing a request, consistent with an embodiment of the invention;

FIG. 2 is an exemplary block diagram of a device for performing features of embodiments of the invention;

FIG. 3 illustrates an exemplary data structure of a request, consistent with an embodiment of the invention;

FIG. 4 illustrates exemplary types of evaluations for requests, consistent with an embodiment of the invention;

FIG. 5 is a general flow diagram of an exemplary method for evaluating and handling a request from a client, consistent with an embodiment of the invention;

FIG. 6 is a flow diagram of another exemplary method for evaluating and handling a request from a client, consistent with an embodiment of the invention; and

FIG. 7 is a flow diagram of an exemplary method for performing a security related evaluation, consistent with an embodiment of the invention.

### DETAILED DESCRIPTION

Reference will now be made in detail to implementations and embodiments of the invention, examples of which are illustrated in the accompanying drawings. Wherever possible, the same reference numbers will be used throughout the drawings to refer to the same or like parts.

Consistent with embodiments of the invention, improved methods and systems are provided for handling and routing requests in a network environment. The network environment may include one or more network switches for handling requests between a client and a server. In one embodiment, to improve performance, requests may be evaluated at a network switch before routing the requests to a server. The evaluation of a request may be performed to determine, for example, the processing intensity or security risk associated with the request. Additionally, or alternatively, requests may also be evaluated based on their priority level.

By way of example, methods and systems of the invention may be provided for evaluating requests related to Web-based services. In such methods and systems, requests from a client may be routed based on the results of an evaluation for each request. For instance, prior to reaching a server, requests may pass through a number of nodes in a network, such as a network switch. The network switch may route the request to one of a number of servers. In one embodiment, prior to routing the request to a server, the request is evaluated. Based on the evaluation, the request may be modified to enhance the client experience with, for example, a business or company providing services or information through the Web-based environment.

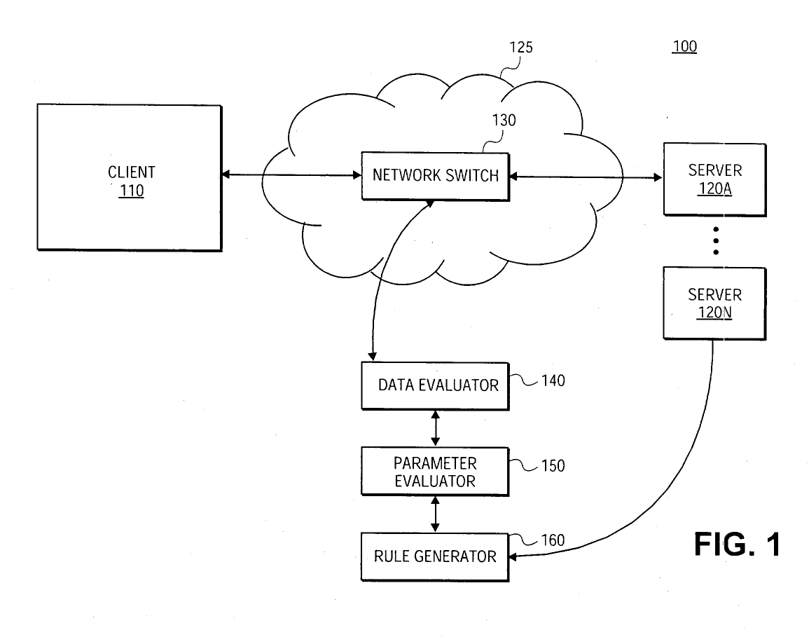

FIG. 1 is block diagram of an exemplary system environment for implementing methods and systems of the present invention. As illustrated in FIG. 1, a system environment 100 is provided that includes a client 110 and a plurality of servers 120A-120N connected by network 125. Communication network 125 includes a network switch 130 for facilitating the communication of requests between client 110 and servers 120A-120N. While FIG. 1 illustrates a plurality of servers 120A-120N, embodiments of the invention may be implemented in system environments in which a single server is provided. Moreover, while only a single client 110 and network switch 130 are illustrated in FIG. 1, embodiments of the invention may include a plurality of clients and one or more associated network switches that handle request from such clients.

In FIG. 1, a communication session between client 110 and server 120A is explicitly depicted. However, client 110 may also communicate through network 125 with other servers, including server 120N, etc. As further illustrated in FIG. 1, connected to network switch 130 is data evaluator 140, a parameter evaluator 150, and a rule generator 160. Components 140, 150,160 may be connected to one or more network switches, or a set of these components may be dedicated and connected to each network switch of network 125.

Network 125 may be the Internet, a wide area network (WAN), a local area network (LAN) or a proprietary network such as a private intranet. System environment 100 is suitable for use with the conventional programming languages such as Java™, Python™, C++, SQL™, and other like programming languages.

Client 110, servers 120A-120N, network switch 130, data evaluator 140, parameter evaluator 150, and rule generator 160 may all be individual computers, or one or more of these components may be running together on one computer. They may be implemented with a mainframe computer or a personal computer, such as an Apple PowerMacintosh or Pentium-based personal computer running a version of the Windows operating system.

Network switch 130 may be a switch, gate, or bridge before a server or firewall. It can have any physical or logical location. Further, network switch 130 may be enabled to interconnect one or more networks or devices, and can forward packets from one network or device to another. For example, network switch 130 routes packets of data from client 110 to servers 120A-120N. In one embodiment, network switch 130 may be associated with a particular set of servers. In still another embodiment, when client 110 sends a request to servers 120A-120N through network 125 connected by network switch 125, client 110 sends the request to network switch 130 and not directly to servers 120A-120N. In yet another embodiment, the requests may be split into packets. In such a case, packets can be collected into a request before evaluation. In one embodiment, network switch 130 may be the gateway switch before the servers or web services for a given network, such as servers 120A-120N.

In system environment 100 of FIG. 1, client 110 communicates with servers 120A-120N through network 125. Servers 120A-120N may comprise a single server or a plurality of servers acting in conjunction with one another. In one embodiment they may represent web services, which perform a specific function, such as Microsoft Passport or conversion of currency. By way of example, servers 120A-120N may be owned or operated by a business or company that provides information or services to clients. Servers 120A-120N may be implemented as clusters or common pools of servers for providing information or services to such clients through network 125. Certain servers may be designated for special access to only preferred clients or to respond to high priority requests from clients. Further, one or more the servers 120A-120N may be embodied with similar functionality to handle multiple requests and simultaneously provide such information or services to different clients.

In one embodiment, communication between client 110 and servers 120A-120N may be conducted through a Web-based environment in which client-server communications are transmitted via the HTTP protocol. Network switch 130 may monitor and capture communications (i.e., requests and responses) between client 110 and one of the servers 120A-120N. Examples of the capture of communications can be found in U.S. Pat. No. 6,286,030 for Systems and Methods for Recording and Visually Recreating Sessions in A Client-Server Environment, issued on Sep. 4, 2001 and U.S. Pat. No. 6,286,098 for System and Method for Encrypting Audit Information in Network Applications, issued on Sep. 4, 2001. In particular, network switch 130 captures requests from client 110 to one of the servers 120A-120N and/or captures responses from one of the servers 120A-120N to client 110. Network switch 130 may send the captured request to data evaluator 140. Data evaluator 140 evaluates the request and may send a modified request back to network switch 130.

By way of non-limiting example, data evaluator 140 may evaluate requests based on a rule, and then take an action based on the evaluation. The rule is comprised of a template, such as “a>b, then c” and parameters, such as “b=10.” The template and the parameters are evaluation criteria which can be used to evaluate requests, and can be updated based on results. Parameters are generated by parameter evaluator 150, and these may be used to update the rules evaluated by data evaluator 140 at periodic intervals.

In another embodiment, data evaluator 140 may send statistics about the use of data evaluator to parameter evaluator 150. Parameter evaluator 150 may process the data and send processed data to rule generator 160, which in turn may generated and send new templates to parameter evaluator 150. The templates generated by rule generator 160 may be used by parameter evaluator 150 to create parameter for a rule which data evaluator 140 can evaluate or process data with. Rule generator 160 may also receive data from each of the servers 120A-120N and send new templates to parameter evaluator 150. For example, rule generator 160 may generate the template “IF a>x then z=x′.” This template may be generated by a person, based on information important to a company, or it may be generated by the computer system. Parameter evaluator 150 will generate parameters for x and x′. The parameters may be generated by the receipt of statistics on the use of data evaluator 140. Data evaluator 140 will run the template with the generated parameter, and then send to parameter evaluator 150 the values received.

In one embodiment, the data received from servers 120A-120N, i.e. server data, includes information about server loads, information about server priorities, and other information about the functioning of the servers. This information may include relative processing loads of the servers. In one embodiment, the relative processing loads of the servers may be determined by comparing the time it takes each server to respond to the same type of request. In another embodiment, the number of requests each server receives in a set time period may be considered.

In one embodiment, a rule can be a general rule about how to respond to an action. An example of a rule is: If request comes from John Premium, then route it to a premium server. The template may be: If request comes from <Parameter1>then route it to the <Parameter2>server. Rule generator 160 may define a template, i.e. come up with a question with no specifics. Parameter evaluator 150 fills in<Parameter1>and <Parameter2>of the template with rule parameters <John Premium>and <premium>. In one embodiment, it may take milliseconds to run data evaluations, days to run parameter evaluation, and indefinite amounts of time to run rule generation.

In one embodiment, data evaluator 140 logs the time at which a request is made and the time at which a response to the request is generated. Data evaluator 140 may also calculate the time it takes for a server to respond to the request (i.e., the response time). Based on server response time, data evaluator 130 may determine the relative response times of the servers 120A-120N.

Parameter evaluator 150 may create a set of rules for one or more clients. For example, rules may be based on response times, e.g., send client “X's” request to a server with the shortest relative response time. In this example, upon receipt of a request from client X, data evaluator 140 forwards user X's request to the server with the shortest relative response time. Rules may also be based on the origin of the request and/or the type of task embodied in the request.

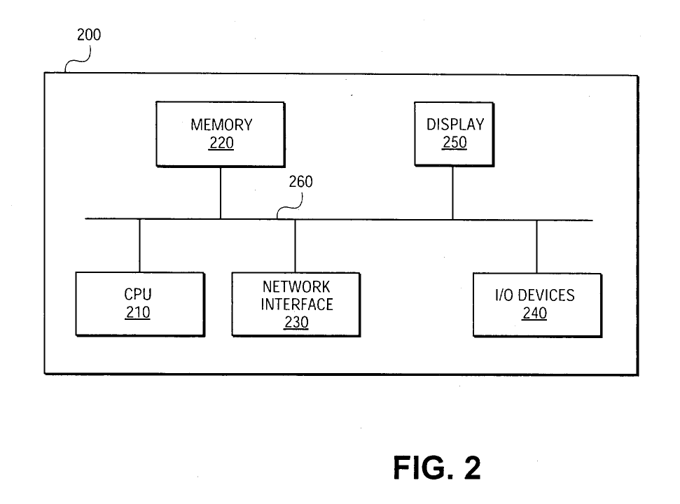

FIG. 2 is an internal block diagram of an exemplary computer system 200, in which methods and system components of the invention may be implemented. Computer system 200 may represent, for example, the components of the clients, servers, network switches, data evaluator, parameter evaluator or rule generator in FIG. 1. By way of example, a program or set of instructions to run the evaluation at the network switch may be implemented in computer system 200.

Computer system 200 may be, for example, a conventional personal computer (PC), a desktop and hand-held device, a multi-processor computer, a pen computer, a microprocessor-based or programmable consumer electronics, a minicomputer, a mainframe computer, a personal mobile computing device, a mobile phone, a portable or stationary personal computer, a Palmtop computer or other such computers known in the art.

Computer system 200 includes a CPU 210, a memory 220, a network interface 230, I/O devices 240, and a display 250, that are all interconnected via a system bus 260. As shown in FIG. 2, computer system 200 contains a central processing unit (CPU) 210. CPU 210 may be a microprocessor such as the Pentium® family of microprocessors manufactured by Intel Corporation. However, any other suitable microprocessor or micro-, mini-, or mainframe computing devices may be used, such as a micro-controller unit (MCU), digital signal processor (DSP).

Memory 220 may include a random access memory (RAM), a read-only memory (ROM), a video memory, mass storage, or cache memory such as fixed and removable media (e.g., magnetic, optical, or magnetic optical storage systems or other available mass storage technology).

Memory 220 stores support modules such as, for example, a basic input output system (BIOS), an operating system (OS), a program library, a compiler, an interpreter, and a text-processing tool. Support modules are commercially available and can be installed on computer 200 by those of skill in the art. For simplicity, these modules are not illustrated. Further, memory 220 may contain an operating system, an application routine, a program, an application-programming interface (API), and other instructions for performing the methods consistent with the invention.

Network interface 230, examples of which include Ethernet or dial-up telephone connections, may be used to communicate with computing systems on network 140. Computer system 200 may also receive input via input/output (I/O) devices 240, which may include a keyboard, pointing device, or other like input devices. Computer system 200 may also present information and interfaces via display 250 to a user.

Bus 260 may be a bi-directional system bus. For example, bus 260 may contain thirty-two address bit lines for addressing a memory 220 and thirty-two bit data lines across which data is transferred among the components. Alternatively, multiplexed data/address lines may be used instead of separate data and address lines.

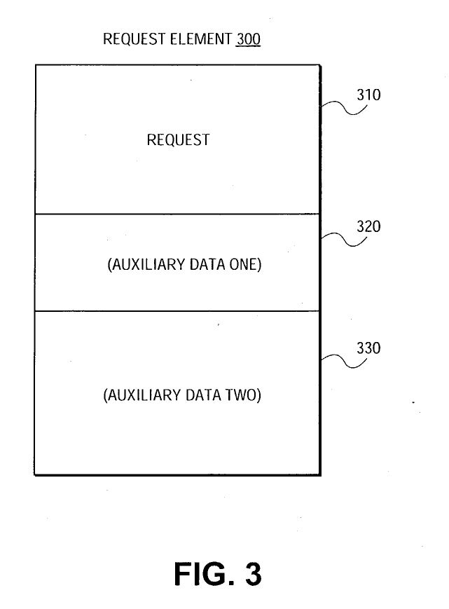

FIG. 3 illustrates an exemplary data structure of a request element 300, consistent with an embodiment of the invention. A request element may be based on a request from client 110 and/or a request that is modified by data evaluator 140 after being received at network switch 130. Exemplary request element 300 contains a request 310, an optional auxiliary data one 320 and an optional auxiliary data two 330. Request 310 may be the URL of a Web page that client 110 wishes to receive from one of the servers 120A-120N (see FIG. 1). Auxiliary data one 320 and/or auxiliary data two 330 may be data indicating the identity of the client. Auxiliary data may also be data inserted by data evaluator 140 (see FIG. 1). For example, this data may indicate the time of the request. The data inserted or identified in request element 300 can be used to better direct the request or provide additional information for the evaluation.

Auxiliary data may be inserted into the request as part of a custom pre-defined cookie stream, a custom pre-defined XML stream or a custom pre-defined HTTP header.

In one embodiment, the first line of request element 300 contains the method to be applied to the object requested, the identifier of the object, and the protocol version in use, followed by further information encoded in the RFC822 header style. By way of example, the format of the request may be:

| | |
|---|---|
| Request | = SimpleRequest \| FullRequest |
| SimpleRequest | = GET <Uri> CrLf |

| | |
|---|---|
| FullRequest | = Method URI ProtocolVersion CrLf |

[*<HTRQ Header>]

[<CrLf> <data>]

| | |
|---|---|
| <Method> | = <InitialAlpha> |

| | |
|---|---|
| ProtocolVersion | = HTTP/1.0 |

| | |
|---|---|
| uri | = <as defined in URL spec> |

| | |
|---|---|
| <HTRQ Header> | = <Fieldname> : <Value> <CrLf> |
| <data> | = MIME-conforming-message |

The MIME conforming message in the “<data>” section of request element 300 may contain auxiliary data one 320. An example of the data may be “Profiletype=Premium.”

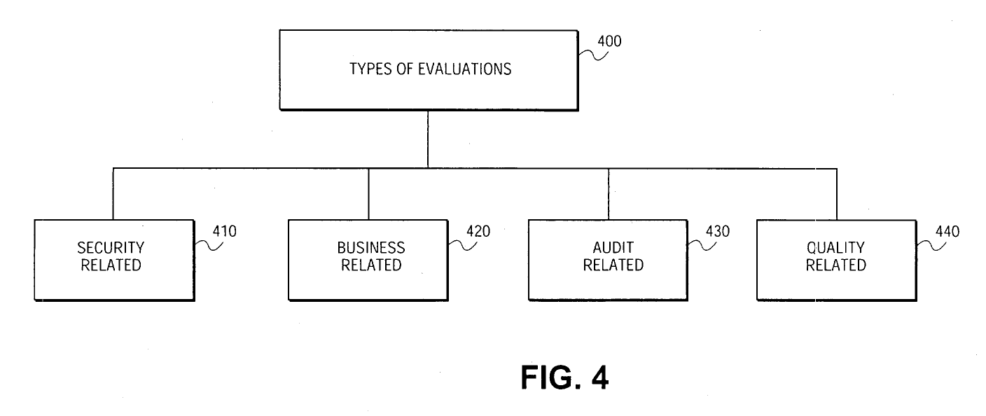

FIG. 4 illustrates exemplary types of evaluations that may be performed on a request, consistent with an embodiment of the invention. The types of evaluations 400 that can be performed on a request may include one or more of the evaluations 410-440 illustrated in FIG. 4. These evaluations types may include security related 410, business related 420, audit related 430 and quality related 440 evaluations. As can be appreciated by those skilled in the art, other types of evaluations beyond those identified in FIG. 4 can also be implemented. Based on evaluations, requests can be handled, such that they are modified, allowed or denied. As can be appreciated by those skilled in the art, other types of handling beyond those identified in FIG. 4 can also be implemented.

Security related 410 evaluations may include isolating risky requests from servers. For example, a request may be evaluated to detect threats posed to a server, such as viruses. Based on the security related evaluations, the request can be denied or manipulated to become harmless. For example, in one embodiment, the request contains an auxiliary data flag called SessionSecurityThreat. If the SessionSecurityThreat flag changes from a Normal setting to a High setting, then any new requests from the client with the High flag for the SessionSecurityThreat would result in automatic response back to the client. For example, the rule may be:

If “SessionSecurityThreat” > Normal

Then run AccessDenied( ).

Business related 420 evaluations may also be performed, such as routing a request based on user identity and priority. Data evaluator 130 may evaluate the request element 300 and direct the request based on the evaluation. For example, the request element can be routed to a server based on the expected response time from the server and the priority level of the requestor. Business related 420 actions allow the system to understand if a user is “important” and should therefore have access to a faster server. In other embodiments, the rules may indicate that a user needs extra privileges. In further embodiments, based on identity of the user, the user will receive access to specifically directed content instead of general content. In one embodiment, this would be implemented by passing user information to the server.

In another embodiment, the system can be used to limit the use of a network by internal users. For example, the rule for this may be:

IF “http request time” ≦ 17:00 & “http request time” ≧ 9:00

& “http request type” = Allowed_progs( )

THEN Allow_Request( )
ELSE Deny_Request( )

Define Allowed_progs (HTTP_Browser, ERP_System, Office_Apps, Aletering_Tool) In this example, the system checks if a request is during an allowed period (between 17:00 and 9:00) and of an allowed type (the Allowed_progs defined by that function). If these are true then a request will be allowed, if false, then the request denied. In this embodiment, the system can be used to control the types of programs used by employees to access the web.

Audit related 430 actions may be performed to evaluate system performance. For example, data evaluator 140 may evaluate request/response logs to determine the response time for different types of requests. In other embodiments, the audit related 430 evaluations may be performed to survey the response/request log and evaluate how the system is being used. This information can be parlayed into modifications to the overall server structure to optimize performance based on the types of requests made to a system. The modifications to the sever structure may be implemented by sending reports on system use to a server administrator, sending programs to the sever to implement changes, such as changing the types of requests particular servers receive, or other known methods for modifying server interface which are known in the art.

Quality related 440 evaluations may be performed to track response times from various servers and to determine which servers offer the quickest relative response time. This information can be used to track server performance. In other embodiments, quality related evaluations include determination of the completeness of the data sent. In one example, if “End user license agreement” is sent to the client, quality related evaluation would determine if a complete agreement has been sent or only part of the agreement.

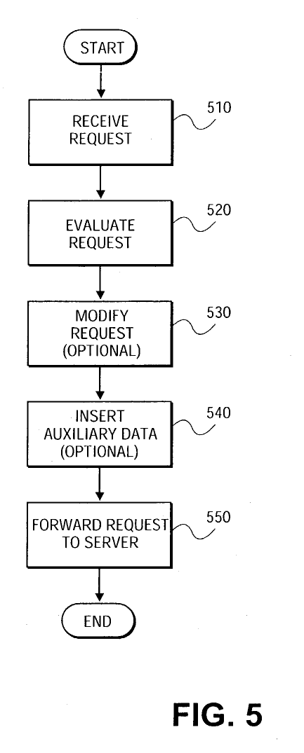

FIG. 5 is a general flow diagram of an exemplary method for evaluating and handling a request from a client, consistent with an embodiment of the invention. As illustrated in FIG. 5, the process begins when a request is received from a client (step 510). For instance, the request may be received by network switch 130 (see FIG. 1). When the request is received, the request may be evaluated (step 520). In this regard, data evaluator 140 may perform one or more evaluations, such as an evaluation for priority level or integrity. Based on this evaluation, the request may be modified (step 530), by for instance inserting auxiliary data (step 540). Such modification may be based on rules generated by rule generator 160. The request is then forwarded to the appropriate server (step 550).

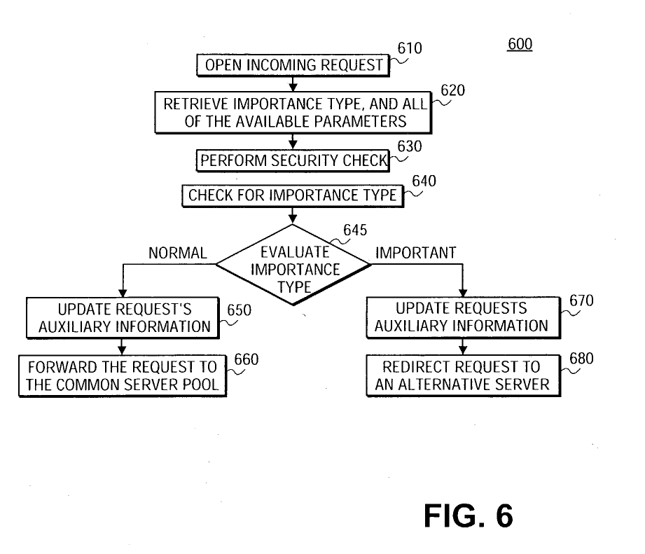

FIG. 6 is a flow diagram of another exemplary method for evaluating and handling a request from a client, consistent with an embodiment of the invention. The exemplary method of FIG. 6 may be performed for conducting a business related evaluation. As can be appreciated by those skilled in the art, other evaluations may be added or combined with the business related evaluation illustrated in the embodiment of FIG. 6.

As illustrated in FIG. 6, an incoming request is opened (step 610). For instance, when a request is received at network switch 130, it may be sent to data evaluator 140 where it is opened. Data evaluator 140 may then retrieve all of the available parameters from the request (step 620). These parameters may include a parameter indicating a priority level or importance type associated with the request. After retrieving the parameters, a security check can be performed (step 630) and the request importance type may be determined (step 640). In the importance check, the request history may be evaluated. The retrieved parameters may be compared to profiles, such as the profile of an important client X. The results of the importance check are evaluated. (step 645). If the request is determined to be from a normal client, then the auxiliary information of the request is updated (step 650) and the request is forwarded to a common server pool (step 660). If the request is determined to be from an important client, then the auxiliary information of the request is updated (step 670), and the request is forwarded to an alternative server pool (step 680).

In one example, the client is a shopper at a Web site who has been making purchase requests. The client's purchase requests are denied, due to lack of availability. The auxiliary information associated with future requests may contain client's past purchase history and denied requests due to unavailability. A rule would trigger an “importance” flag to be on for the client, based on the purchase history and denied request. Every time the client visits the site to buy the same item, a “quality” rule would check the client's importance. Given an important client, the client would be redirected to the least busy server, and the request for items the client wishes to purchase may get redirected to the server that has “Priority” order when it comes to hard to find items.

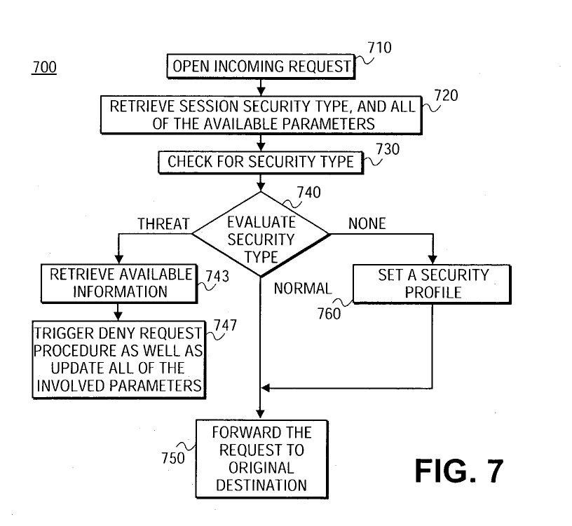

FIG. 7 is a flow diagram illustrating an exemplary method for performing a security evaluation, consistent with an embodiment of the present invention. Based on the security evaluation, request may be allowed, denied, modified, or redirected. First, the data evaluator scans a request (step 710). The security type, and other available parameters, such as hostname, user, or context, are retrieved (step 720). A security type check is performed (step 730). The security type is evaluated (step 740). If the type is determined to be a threat, then information is retrieved from the request and used to update the security profile for the requester (step 743). A deny request procedure is then run (step 747). In one embodiment, deny request in HTTP protocol is performed by sending a response to the client saying that his/her request was denied. If the type is determined to be normal, the request is forwarded to the original destination (step 750). If no security type is found, then a security profile is created (step 760) and the request is forwarded to the original destination (step 750). In one embodiment, a parameter is set by using a “cookie” or by setting a bit in the session ID. In one embodiment, the security profile is saved in a “cookie” stored on the client device.

While embodiments or features of the invention have been described as being stored in memory, one skilled in the art will appreciate that these aspects can also be stored on or read from other types of computer-readable media, such as secondary storage devices, like hard disks, floppy disks, or CD-ROMs; a carrier wave from the Internet; or other forms of RAM or ROM. Similarly, the exemplary methods disclosed herein and other embodiments of the invention may conveniently be implemented in program modules that are based upon the flow charts in FIGS. 5, 6 and 7. No particular programming language has been indicated for carrying out the various procedures described above because it is considered that the operations, stages and procedures described above and illustrated in the accompanying drawings are sufficiently disclosed to permit one of ordinary skill in the art to practice embodiments of the invention. Moreover, there are many computers and operating systems that may be used in practicing the invention and therefore no detailed computer program could be provided which would be applicable to these many different systems. Each user of a particular computer will be aware of the language and tools which are most useful for that user's needs and purposes.

Furthermore, the above-noted features and embodiments of the present invention may be implemented in various environments. Such environments and related applications may be specially constructed for performing the various processes and operations of embodiments of the invention or they may include a general purpose computer or computing platform selectively activated or reconfigured by program code to provide the necessary functionality. The exemplary processes disclosed herein are not inherently related to any particular computer or other apparatus, and aspects of these processes may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

Embodiments of the present invention also relate to computer readable media that include program instructions or program code for performing various computer-implemented operations based on the methods and processes of the invention. The program instructions may be those specially designed and constructed for the purposes of implementing embodiments of the invention, or they may be of the kind well-known and available to those having skill in the computer software arts. Examples of program instructions include for example machine code, such as produced by a compiler, and files containing a high level code that can be executed by the computer using an interpreter.

Other embodiments of the invention will be apparent to those skilled in the art from consideration of the specification and practice of the exemplary embodiments disclosed herein. Therefore, it is intended that the specification and examples be considered as exemplary only, with a true scope and spirit of the invention being indicated by the scope of the following claims and their equivalents.

What is claimed is:

1. A method for handling a request in a network environment including at least one network switch and a plurality of servers or web services, the method comprising:
receiving the request at the network switch;
evaluating the request, wherein evaluation of the request is based on a rule; and
handling the request based on the evaluation.

2. A method of claim 1, wherein the rule contains parameters generated by prior evaluations.

3. A method of claim 1, wherein handling the request includes modifying the request, allowing the request, or denying the request.

4. A method for routing a request in a network environment including at least one network switch and a plurality of servers, the method comprising:
receiving a request at the network switch;
determining the processing intensity of the request; and
performing at least one of:
assessing a plurality of servers to determine the relative processing loads of the servers; and
routing the request to one of the plurality of servers based on the determined intensity and the relative processing loads.

5. A method for routing a request in a network environment including at least one network switch and one or more servers, the method comprising:
receiving a request at the network switch;
determining a security risk associated with the request;
modifying the request based on the determined security risk; and
routing the request to a server based on the security risk of the request.

6. The method of claim 5, wherein routing comprises routing the request to a server based on the removal of the security risk.

7. The method of claim 5, wherein routing comprises routing the request to a special server if a security risk is determined.

8. A method for routing a request in a network environment including at least one network switch and a plurality of servers, the method comprising:
receiving a request at the network switch;
determining a priority level of the request, the priority level indicating a minimum response time; and
routing the request to one of the plurality of servers based on the relative response time for the priory level associated with the request.

9. A method of claim 8, further comprising:
assessing a plurality of servers to determine a relative response time of each server.

10. The method of claim 8, wherein routing comprises routing the request based on a minimum response time.

11. A method for use in a network environment including a plurality of servers, the method comprising:
evaluating a network request/response log;
determining a request/response time for at least one type of request, based on the evaluation of the log; and
modifying the structure of a plurality of servers based on the determined request/response time.

12. The method of claim 11, further comprising:
routing the request to one of the plurality of servers based on the type of request.

13. The method of claim 11, further comprising:
inserting auxiliary data into the request.

14. A method of determining request evaluation criteria, the method comprising:
generating rules for handling requests based on request/response logs and server data;
generating parameters for the rules based a set of current requests; and
updating evaluation criteria based on the generated rules and parameters.

15. The method of claim 14, further comprising:
routing the request to a server based on the updated criteria.

16. The method of claim 14, wherein server data comprises load processing data from a server.

17. A system for handling a request in a network environment including at least one network switch and a plurality of servers or web services, the method comprising:
at least one network switch;
a plurality of servers;
means for receiving the request at the network switch;
means for evaluating the request, wherein evaluation of the request is based on a rule; and
means for handling the request based on the evaluation.

18. A system for routing a request in a network environment comprising:
at least one network switch;
a plurality of servers;
means for receiving a request at the network switch;
means for determining the processing intensity of the request;
means for assessing a plurality of servers to determine the relative processing loads of the servers; and
means for routing the request to one of the plurality of servers based on the determined intensity and the relative processing loads.

19. A system for routing a request in a network environment comprising:
at least one network switch
a plurality of servers;
means for receiving a request at the network switch;
means for determining a security risk associated with the request; and
at least one of:
means for modifying the request based on the determined security risk, or
means for routing the request to a server based on the security risk of the request.

20. The system of claim 19, wherein means for routing comprises routing the request to a server based on the removal of the security risk.

21. The system of claim 19, wherein means for routing comprises routing the request to a special server if a security risk is determined.

22. A system for routing a request in a network environment, the method comprising:
at least one network switch;
a plurality of servers;
means for receiving a request at the network switch;
means for determining a priority level of the request, the priority level indicating a minimum response time; and
means for routing the request to one of the plurality of servers based on the relative response time for the priory level associated with the request.

23. A system of claim 22, further comprising:
means for assessing a plurality of servers to determine a relative response time of each server.

24. The system of claim 22, wherein means for routing comprises routing the request based on a minimum response time.

25. A computer system for use in a network environment including a plurality of servers, comprising:
a memory having program instructions; and
a processor, responsive to the programming instructions, configured to:
evaluate a network request/response log;
determine a request/response time for at least one type of request based on the evaluation of the log; and
modify the structure of a plurality of servers based on the determined request/response time.

26. The system of claim 25, wherein the processor is further configured to:
route the request to one of the plurality of servers based on the type of request.

27. The system of claim 25, wherein the processor is further configured to:
insert auxiliary data into the request.

28. A computer system for determining request evaluation criteria, the system comprising:
a memory having program instructions; and
a processor, responsive to the programming instructions, configured to:
generate rules for routing requests based on request/response logs and sever data;
generate parameters for the rules based a set of current requests; and
update evaluation criteria based on the generated rules and parameters.

29. The system of claim 28, wherein server data comprises load processing data from a server.

30. The system of claim 28, wherein the processor is further configured to:
route the request to a server based on the updated criteria.

31. A computer-readable medium on which is stored instructions, which when executed performs steps in a method for use in a network environment including a plurality of servers, the steps comprising:
evaluating a network request/response log;
determining a request/response time for at least one type of request based on the evaluation of the log; and
modifying the structure of a plurality of servers based on the determined request/response time.

32. A computer-readable medium on which is stored instructions, which when executed performs steps in a method of determining request evaluation criteria, the steps comprising:
generating rules for routing requests based on request/response logs and server data;
generating parameters for the rules based a set of current requests; and
updating evaluation criteria based on the generated rules and parameters.

33. A computer-readable medium on which is stored instructions, which when executed performs steps in a method for handling a request in a network environment including at least one network switch and a plurality of servers or web services, the steps comprising:
receiving the request at the network switch;
evaluating the request, wherein evaluation of the request is based on a rule; and
handling the request based on the evaluation.
